(19) United States
(12) Patent Application Publication
(10) Pub. No.: US 2017/0033642 A1
(43) Pub. Date: Feb. 2, 2017

(54) MOTOR STRUCTURE

(71) Applicant: Wen-San CHOU, TAINAN (TW)

(72) Inventor: Wen-San CHOU, TAINAN (TW)

(21) Appl. No.: 15/214,883

(22) Filed: Jul. 20, 2016

(30) Foreign Application Priority Data
Jul. 28, 2015 (TW) 104124412

(51) Int. Cl. H02K 5/20; H02K 9/06; H02K 5/18

(52) U.S. Cl. CPC H02K 5/20; H02K 5/18; H02K 9/06

(57) ABSTRACT

An improved motor structure includes a housing and a cooling fan for generating an air current that can quickly enter the housing to dissipate heat therein. The housing is pressed to form a plurality of intercepting fins and a plurality of inlet holes. The air current can be guided by the intercepting fins so that it can pass through the inlet holes more easily to enter the inner space of the motor's housing to take away the heat generated in the motor, so that heat is not easy to accumulate in the housing of the motor, and thus maximum power output of the motor can be achieved. Therefore, the performance and service life of the motor can be increased.

### TECHNICAL FIELD OF THE INVENTION

The present invention relates to an improved motor structure and, more particularly, to a motor which can effectively dissipate the heat generated in its housing through multiple paths, so that heat is not easy to accumulate in the motor's housing, and thus the performance and service life of the motor can be increased.

### DESCRIPTION OF THE PRIOR ART

In today's industry, motors are one of commonly used devices for providing mechanical power. However, while a motor is running, heat is easy to accumulate in the motor's housing. If the heat is not timely dissipated, the magnetic field provided by the magnets in the motor's housing will decrease, so that the performance of the motor can be gradually reduced. Besides, when the temperature in the motor rises to a certain level, the coils or enamel wires in the motor can be damaged, and this may cause a short circuit, and thus the motor may burn out. For preventing such a problem, a motor is usually provided with a cooling fan. However, the air current generated by the cooling fan of the motor can merely flow along the outer surface of the motor's housing, but cannot flow into the interior of the motor, and thus the capacity of dissipating the heat generated in the motor is limited. The problem of heat accumulation in the motor's housing has not yet been solved completely.

### SUMMARY OF THE INVENTION

One object of the present invention is to provide a motor, which can effectively dissipate the heat generated in its housing through multiple paths.

According to one feature of the present invention, the motor generally includes a housing, a front cover, a rotating shaft, and a cooling fan. The housing defines therein an inner space with a front opening. The front cover closes the front opening of the housing and defines a central hole. The surrounding wall of the housing is pressed to form a plurality of air intercepting fins, which are bent outwardly such that a plurality of first inlet holes are defined next to the corresponding air intercepting fins, whereby an outer portion of a whirling, ongoing air current generated by the cooling fan can be guided by the air intercepting fins to pass through the first inlet holes and thus to enter the housing for dissipating heat therein.

According to another feature of the present invention, an air passage is formed on the housing, between two adjacent intercepting fins to allow some of the outer portion of the air current to flow along an outer surface of the housing to cool down the temperature of the housing.

According to one advantage of the present invention, the motor can be used in a high-temperature environment without being damaged. In a test, the motor was continuously operated in a closed space of 70 degrees C. for a long time without burning out.

Other objects, advantages, and novel features of the present invention will become more apparent from the following detailed description when taken in conjunction with the accompanying drawings.

### BRIEF DESCRIPTION OF THE DRAWINGS

FIG. 1 shows an exploded view of a motor according to one embodiment of the present invention.

FIG. 2 shows a 3-dimensional view of the motor.

FIG. 3 shows another 3-diemensional view of the motor, which is viewed from a different angle than FIG. 2.

FIG. 4 shows a 3-deminsional view of a front cover used in the motor.

FIG. 5 shows a plan view of the motor.

FIG. 6 shows a sectional view of the motor taken along line E-E in FIG. 5, which demonstrates one portion of the air current being guided by the air intercepting fins to enter the inner space of the motor's housing for dissipating the heat generated in the motor.

FIG. 7 shows a sectional view of the motor taken along line F-F in FIG. 5, which demonstrates one portion of the air current being guided by the air intercepting fins to enter the inner space of the motor's housing for dissipating the heat generated in the motor.

FIG. 8 shows a working view of the motor, which demonstrates that the air current can flow out of the motor's housing via the outlet holes thereof to take away the heat generated in the motor.

### DETAILED DESCRIPTION OF THE PREFERRED EMBODIMENTS

Since the structure and operational principles of a motor have been known widely, a detailed description for the constituent parts thereof is not provided in the following paragraphs.

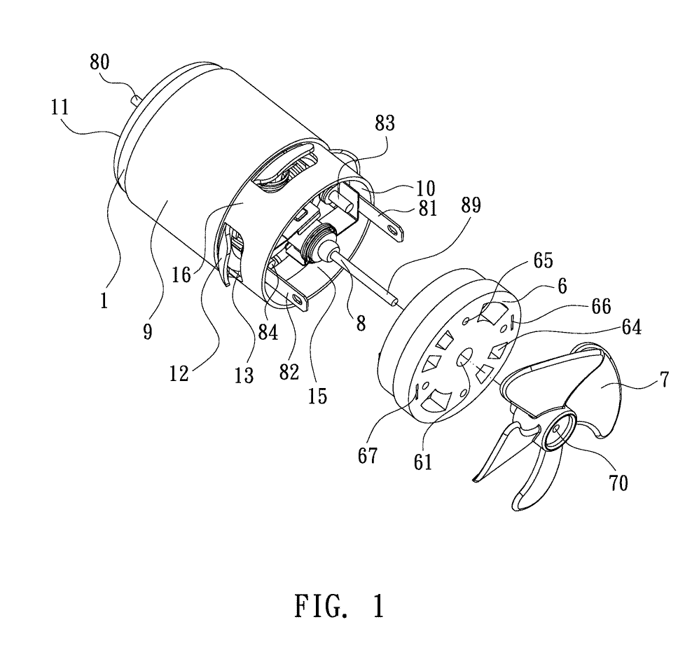

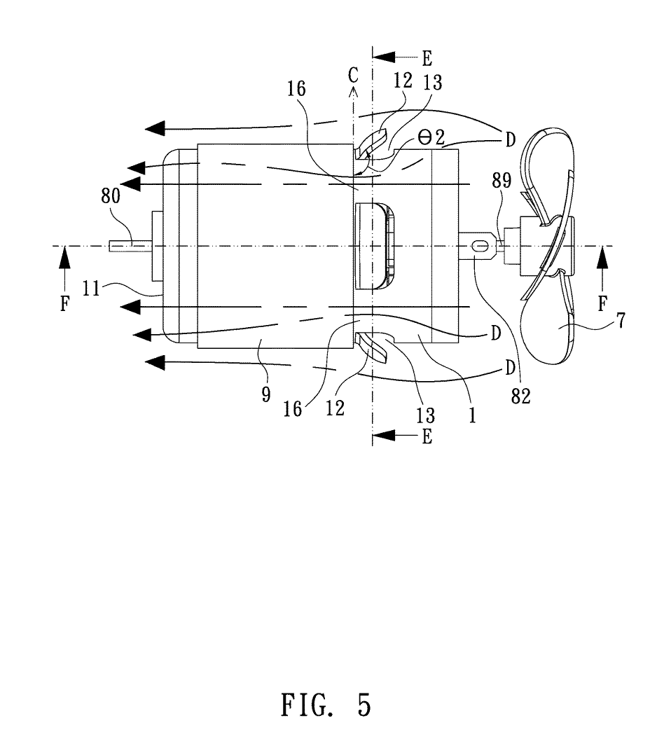

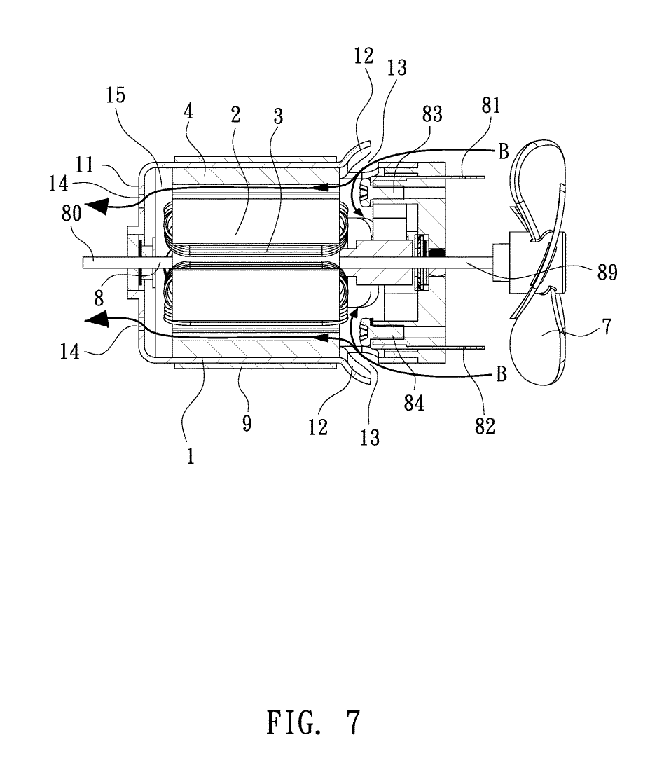

Retelling first to FIGS. 1 through 3, a motor according to one embodiment of the present invention is shown, which generally includes a housing 1, a front cover 6, a rotating shaft 8, and a cooling fan 7. The housing 1 defines therein an inner space 15 with a front opening 10 and has a rear closure wall 11 opposite to the front opening 10. The rear closure wall 11 defines a central hole, in which a bearing may be mounted, and a plurality of outlet holes 14 around the central hole. The surrounding wall of the housing 1 is pressed to form a plurality of air intercepting fins 12, which are bent outwardly such that a plurality of inlet holes 13 are defined next to the corresponding air intercepting fins 12. The air intercepting fins 12 extend generally towards the front opening 10 of the housing 1 or the cooling fan 7, at a predetermined angle of (Θ2) to a cross-sectional plane (C) of the housing 1 which is perpendicular to the rotating shaft 8 (see FIG. 5), wherein the predetermined angle (Θ2) is greater than 90 degrees. Since there is no obstruction between two adjacent intercepting fins 12, a plurality of air passages 16 are formed between the intercepting fins 12. Furthermore, a rotor 2, coils 3 and magnets 4, which are necessary elements for a motor, are provided in the inner space 15 of the housing 1 (see FIG. 7). The rotating shaft 8 is mounted across the inner space 15 of the housing 1, wherein the rotating shaft 8 has a first end 80 which is inserted through the central hole of the rear closure wall 11 for connecting with a transmission mechanism (not shown) for providing necessary mechanical power. The rotating shaft 8 has a second end 89 which is inserted out of the front opening 10 of the housing 1 to be fitted with the cooling fan 7, as will be further illustrated below. A magnetically permeable sleeve 9, which can be made of metal, is closely fitted around the outer surface of the housing 1, to increase the performance of the motor.

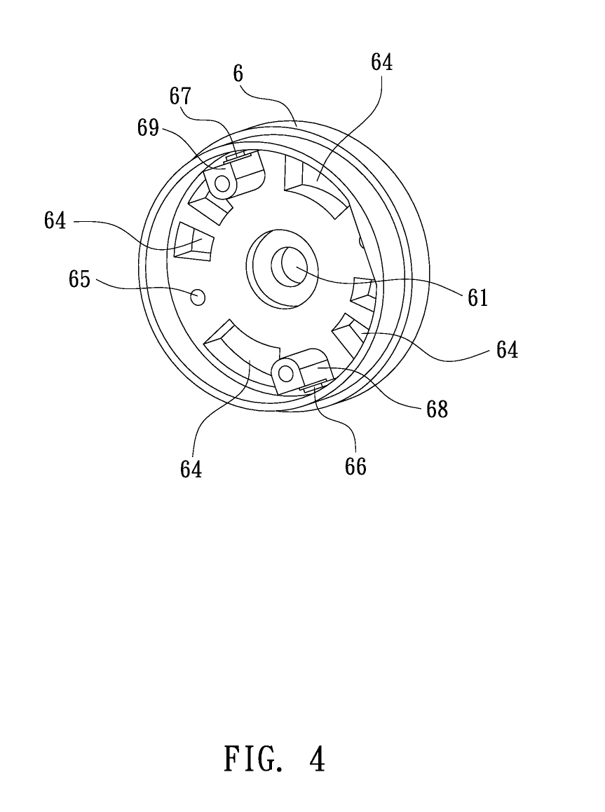

The front cover 6 defines a central hole 61 and a plurality of inlet holes 64 around the central hole 61. Furthermore, the front cover 6 defines two through holes 66, 67, and is provided with two mounting tubes 68,69 (see FIG. 4) at its inner surface. When the front cover 6 is installed to the housing 1, two electrical terminal blades 81, 82 provided in the housing 1 can be inserted through the two through holes 66, 67 of the front cover 6, while two fixing dowel rods 83, 84 provided in the housing 1 can be inserted into the mounting tubes 68, 69 of the front cover 6, so that the front cover 6 closes the front opening 10 of the housing 1, and electrical connection for the motor is facilitated. Furthermore, the front cover 6 defines a plurality of fixing holes 65, through which a plurality of screws can be engaged with other portions of the housing 1 (not shown), so that the front cover 6 can be installed to the housing 1 more firmly. While the front cover 6 is being installed to the housing 1, the second end 89 of the rotating shaft 8 can be inserted through the central hole 61 of the front cover 6, wherein a bearing (not shown) may be provided in the front cover 6 and fitted with the second end 89 of the rotating shaft 8.

The cooling fan 7 defines a central hole 70, into which the second end 89 of the rotating shaft 8 extending out of the central hole 61 of the front cover 6 can be fitted, so that the cooling fan 7 is attached to and rotated together with the rotating shaft 8.

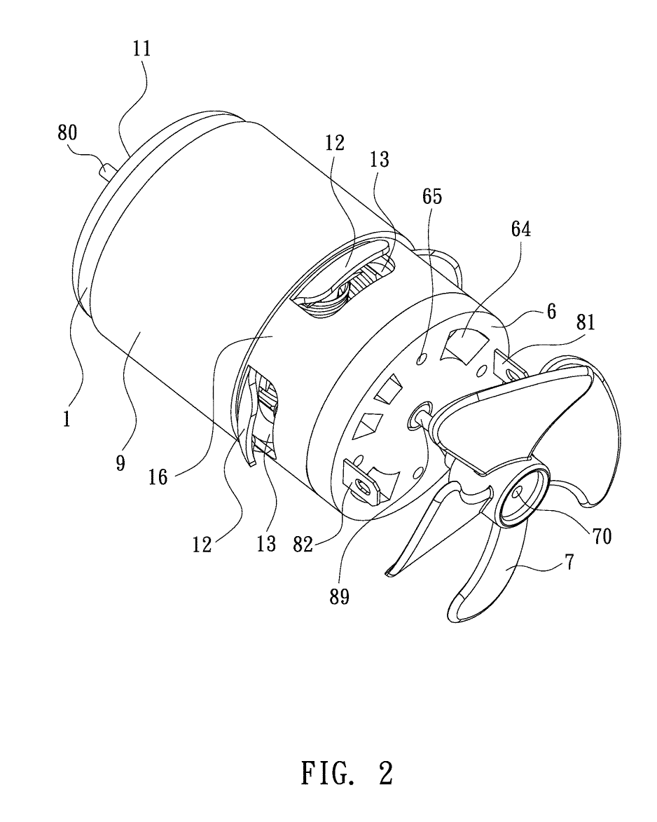

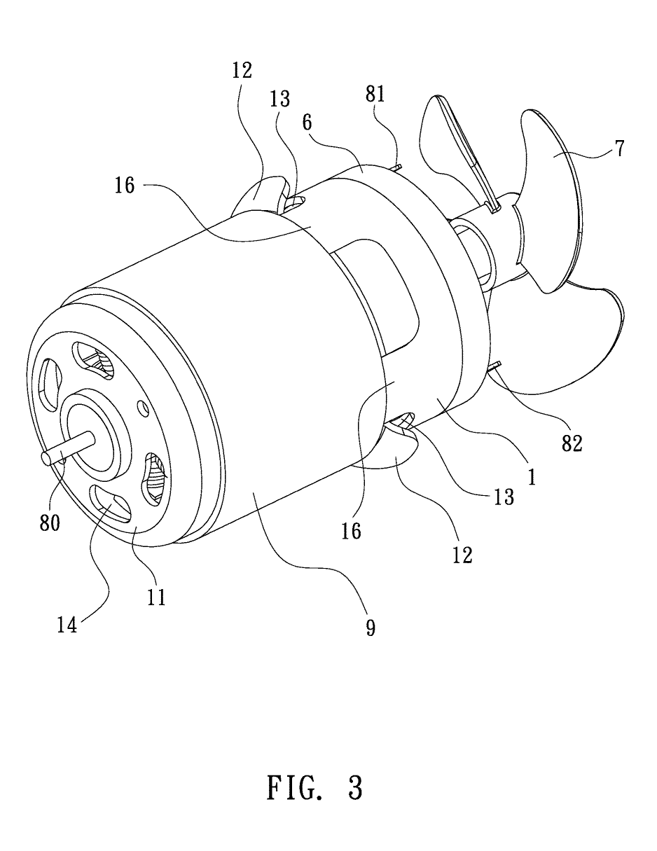

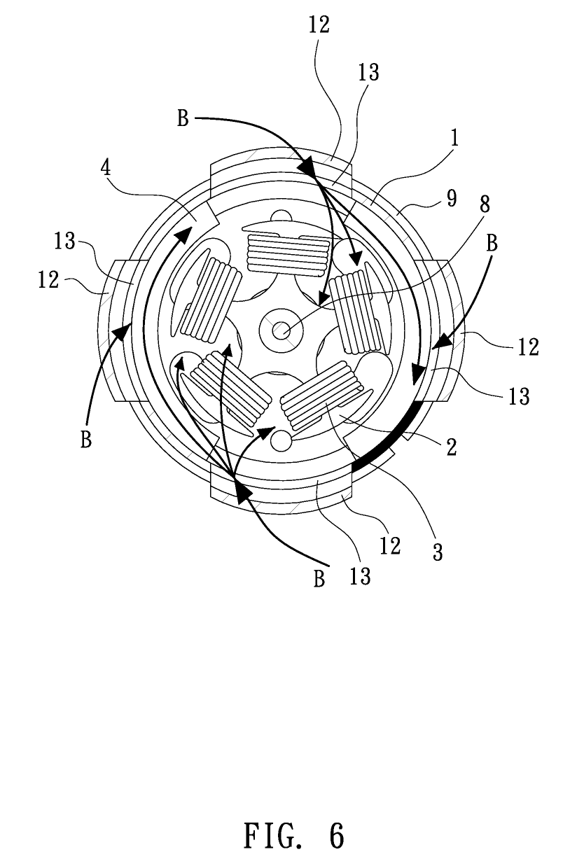

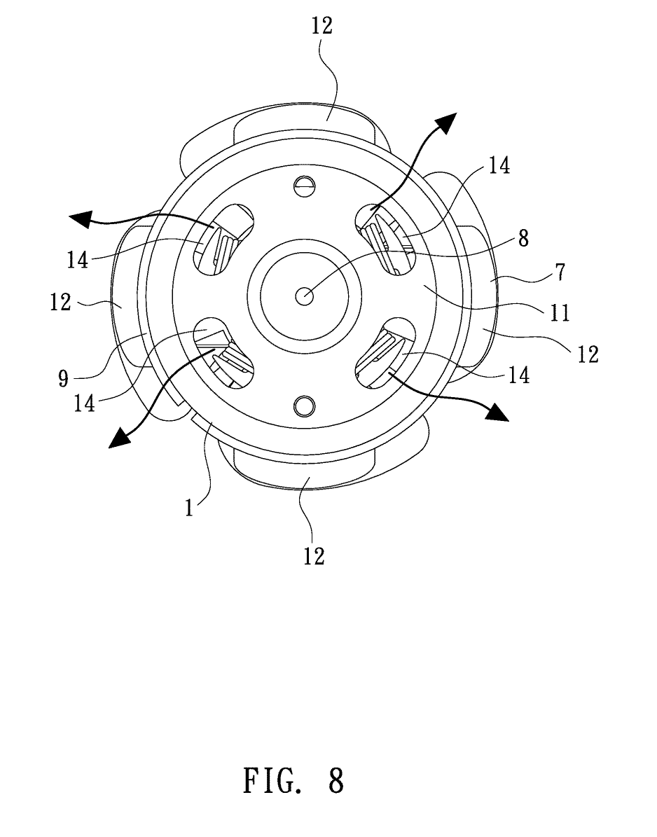

FIGS. 2 and 3 show one embodiment of the motor being assembled from the housing 1, the front cover 6, and the cooling fan 7. When the motor is started, the cooling fan 7 can be rotated together with the rotating shaft 8 to generate a whirling, ongoing air current towards the front cover 6, so that the air at the fight side of the cooling fan 7 can be forced to flow into the left side of the cooling fan 7 (see FIG. 5). In particular, the air current can enter the inner space 15 of the housing 1 easily, and the heat generated in the housing 1 can be dissipated effectively through multiple paths (see FIGS. 5, 6 and 7). In addition to a central portion of the air current generated by the cooling fan 7 flowing into the housing 1 via the inlet holes 64 of the front cover 6, an outer portion of the air current, which is outside the area of the front cover 6 and constitutes a large portion of the air current, may enter the inner space 15 of the housing 1 via the inlet holes 13 of the housing 1. Specifically, the most part of the outer portion of the air current can be guided or intercepted by the intercepting fins 12 to pass through the corresponding inlet holes 13 and thus to enter the inner space 15 of the housing 1, as indicated by the airflow path (B) shown in FIG. 7, so that the temperatures of the rotor 2, the coils 3, and the magnets 4 in the housing 1 can be restrained effectively. On the other hand, the rest of the outer portion of the air current may flow along the outer surface of the housing 1 or the sleeve 9 via the air passages 16 between the intercepting fins 12 of the housing 1, as indicated by the airflow path (D) shown in FIG. 5, so that the housing 1 can be effectively cooled down to facilitate dissipation of the heat generated in the housing 1. In this embodiment, the air current which has entered the inner space 15 of the housing 1 can flow out of the housing 1 via the outlet holes 14 (see FIGS. 7 and 8).

As a summary, the intercepting fins 12 and the associated inlet holes 13 of the housing 1 allow the motor of the present invention to provide an airflow path (B) via which the most part of the outer portion of the air current generated by the cooling fan 7 enters the inner space 15 of the housing 1 to dissipate the heat generated in the housing 1. In addition, the air passages 16 between the intercepting fins 12 of the housing 1 allow the motor of the present invention to provide another airflow path (D) via which the rest of the outer portion of the air current flows along the outer surface of the housing 1 to lower the temperature of the housing 1 and thus to increase the capacity of dissipating the heat generated in the housing 1. Through multiple paths for heat dissipation, heat is not easy to accumulate in the housing 1 of the motor; therefore, maximum power output of the motor can be achieved, and thus the performance and service life of the motor can be increased. Even though the motor is operated in a high-temperature environment, it will not burn out. These features render the motor of the present invention useful and inventive.

I claim:

1. In a motor including a housing, a front cover, a rotating shaft, and a cooling fan, wherein the housing defines therein an inner space with a front opening and has a rear closure wall opposite to the front opening, the rear closure wall defining a central hole and a plurality of outlet holes; the front cover closes the front opening of the housing and defines a central hole; the rotating shaft is mounted across the inner space of the housing, the rotating shaft having a first end which is inserted through the central hole of the rear closure wall and having a second end which is inserted through the central hole of the front cover; the cooling fan is fixed to the second end of the rotating shaft, so that the cooling fan is rotated together with the rotating shaft; wherein the improvement comprises:
the housing is pressed to form a plurality of air intercepting fins, which are bent outwardly such that a plurality of first inlet holes are defined next to the corresponding air intercepting fins, whereby an outer portion of a whirling, ongoing air current generated by the cooling fan can be guided by the air intercepting fins to pass through the first inlet holes and thus to enter the housing for dissipating heat therein.

2. The motor of claim 1, wherein the air intercepting fins extend generally towards the cooling fan, at a predetermined angle of (Θ2) to a cross-sectional plane (C) of the housing which is perpendicular to the rotating shaft, the predetermined angle (Θ2) being greater than 90 degrees.

3. The motor of claim 1, wherein an air passage is formed on the housing between two adjacent intercepting fins to allow some of the outer portion of the air current to flow along an outer surface of the housing.

4. The motor of claim 1, wherein the front cover defines a plurality of second inlet holes around its central hole to allow a central portion of the air current to enter the inner space of the housing to cool down the temperature of the housing.

5. The motor of claim 1, wherein the front cover defines two through holes which allows two electrical terminal blades provided in the housing to insert therethrough to facilitate electrical connection and installing the front cover to the housing.

6. The motor of claim 5, wherein the front cover is provided at its inner surface with a plurality of mounting tubes which allows fixing dowel rods provided in the housing to insert thereinto so as to install the front cover to the housing, thereby closing the front opening of the housing.

7. The motor of claim 6, wherein the front cover defines a plurality of fixing holes, through which a plurality of screws are engaged with other portions of the housing, so that the front cover can be installed to the housing more firmly.
